(19) United States
(12) Patent Application Publication
(10) Pub. No.: US 2017/0339135 A1
(43) Pub. Date: Nov. 23, 2017

(54) AUTHENTICATION SYSTEM, COMMUNICATION SYSTEM, AND AUTHENTICATION METHOD

(71) Applicants: Hiroshi HINOHARA, Kanagawa (JP); Naoki UMEHARA, Kanagawa (JP); Atsushi MIYAMOTO, Kanagawa (JP); Takeshi HORIUCHI, Tokyo (JP); Takuya SONEDA, Kanagawa (JP)

(72) Inventors: Hiroshi HINOHARA, Kanagawa (JP); Naoki UMEHARA, Kanagawa (JP); Atsushi MIYAMOTO, Kanagawa (JP); Takeshi HORIUCHI, Tokyo (JP); Takuya SONEDA, Kanagawa (JP)

(21) Appl. No.: 15/491,088

(22) Filed: Apr. 19, 2017

(30) Foreign Application Priority Data
May 18, 2016 (JP) 2016-099694

(51) Int. Cl. H04L 29/06

(52) U.S. Cl. CPC H04L 63/0853; H04L 63/083; H04L 63/101

(57) ABSTRACT

An authentication system, a communication system, and an authentication method. The authentication system and the authentication method include receiving additional information where first identification information of a communication terminal is added to second identification information of a target to be authenticated, and authenticating the target to be authenticated using the second identification information of the target to be authenticated. When the target to be authenticated is authenticated by the authenticating, an account associated with the additional information is authorized to receive information that is sent from the communication terminal to another communication terminal. The communication system includes the authentication system and an authorization system including circuitry to authorize the account associated with the authorization data to receive information that is sent from the communication terminal to another communication terminal when the target to be authenticated is authenticated by the first circuitry.

### CROSS-REFERENCE TO RELATED APPLICATION

This patent application is based on and claims priority pursuant to 35 U.S.C. §119(a) to Japanese Patent Application No. 2016-099694, filed on May 18, 2016, in the Japan Patent Office, the entire disclosure of which is hereby incorporated by reference herein.

### BACKGROUND

### Technical Field

Embodiments of the present disclosure relate to an authentication system, a communication system, and an authentication method.

### Background Art

With the need for reducing costs or times associated with business trips in recent years, communication systems are widely used, which are capable of carrying out videoconferences among remotely located sites through a communication network such as the Internet or private lines. In such communication systems, an authentication system is arranged to authenticate a user for each communication terminal. Accordingly, a user can be identified for every communication terminal, and communication among users that are specified by a communication terminal can be performed.

Moreover, automatically assigning systems that automatically assign user account names are known. In such automatically assigning systems, after a communication terminal is connected to the network and before the communication terminal accesses the server software of an application server, the communication terminal obtains the host address of the network that is assigned by the dynamic host configuration protocol (DHCP) server, and then generates a user account name with the host address as the suffix. Accordingly, the user account names are automatically assigned.

### SUMMARY

Embodiments of the present disclosure described herein provide an authentication system, a communication system, and an authentication method. The authentication system and the authentication method include receiving additional information where first identification information of a communication terminal is added to second identification information of a target to be authenticated, and authenticating the target to be authenticated using the second identification information of the target to be authenticated. When the target to be authenticated is authenticated by the authenticating, an account associated with the additional information is authorized to receive information that is sent from the communication terminal to another communication terminal. The communication system includes the authentication system and an authorization system including circuitry to authorize the account associated with the authorization data to receive information that is sent from the communication terminal to another communication terminal when the target to be authenticated is authenticated by the first circuitry.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a schematic diagram illustrating a configuration of a communication system according to an embodiment of the present disclosure.

FIG. 2 is a schematic block diagram illustrating a hardware configuration of a communication terminal according to an embodiment of the present disclosure.

FIG. 3 is a schematic block diagram illustrating a hardware configuration of a management system according to an embodiment of the present disclosure.

FIG. 4 is a schematic block diagram illustrating a software configuration of a communication terminal according to an embodiment of the present disclosure.

FIG. 5 is a functional block diagram of a communication terminal, an authentication server, and a management system, according to an embodiment of the present disclosure.

FIG. 6A, FIG. 6B, FIG. 6C, and FIG. 6D are diagrams each illustrating a data structure of a management table managed by an authentication server, according to an embodiment of the present disclosure.

FIG. 7A, FIG. 7B, FIG. 7C, and FIG. 7D are diagrams each illustrating a data structure of a management table managed by a management system, according to an embodiment of the present disclosure.

FIG. 8 is a sequence diagram illustrating authentication processes according to an embodiment of the present disclosure.

FIG. 9 is a flowchart of user authentication processes according to an embodiment of the present disclosure.

FIG. 10 is a sequence diagram illustrating the processes of sending a message among communication terminals, according to an embodiment of the present disclosure.

FIG. 11 is a flowchart of the processes of determining whether or not each communication terminal has the authority to subscribe to a message, according to an embodiment of the present disclosure.

FIG. 12 is a flowchart of the processes of determining whether or not each communication terminal has the authority to publish a message, according to an embodiment of the present disclosure.

FIG. 13 is a sequence diagram illustrating the processes of sending a message among communication terminals, according to an embodiment of the present disclosure.

FIG. 14 is a sequence diagram illustrating authentication processes according to an embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs), computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In the following description, an embodiment of the present invention is described with reference to the drawings.

<<Schematic Configuration of Communication System>>

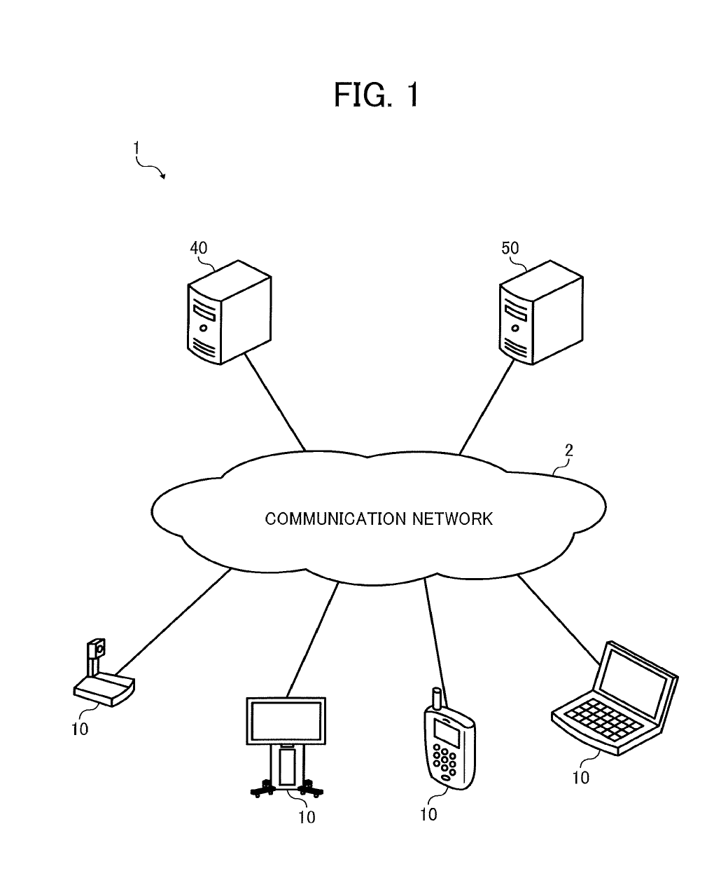

FIG. 1 is a schematic diagram illustrating a configuration of a communication system according to the present embodiment. As illustrated in FIG. 1, the communication system 1 includes a communication terminal 10, an authentication server 40, and a management system 50.

The management system 50 is a server that receives a message publication request and a message subscription request from clients in the publish-subscribe model. Such message publication requests and message subscription requests are used to exchange messages among clients. The publish-subscribe model may be referred to simply as a pub/sub model, and publication and subscription may be referred to simply as pub and sub, respectively. As a protocol compatible with the pub/sub model, for example, the management system 50 may be provided with Message Queue Telemetry Transport (MQTT) or a pub/sub extension (XEP-0060) of Extensible Messaging and Presence Protocol (XMPP).

The communication terminal 10 may be, for example, a general-purpose communication terminal, and may be installed with a desired client application. Alternatively, the communication terminal 10 may be, for example, a communication terminal that is designed for exclusive use, and may be installed with a specific client application that serves as a client.

The communication terminal 10 is connected to the management system 50 through a communication network 2. Accordingly, the clients of the communication terminal 10 can request message pub and message sub from the management system 50. The communication terminal 10 may be, for example, a television conference terminal, an electronic whiteboard, digital signage, a telephone, a tablet personal computer (PC), a smartphone, a camera, and a PC. The authentication server 40 is a server that authenticates a client, which is a client application operating on the communication terminal 10, and a user who uses that client, respectively, to authorize the use of the management system 50. In order to implement such authentication and authorization as above, the management system 50 is provided with an authenticating or authorizing protocol such as OAuth 2.0 or OpenID Connect.

For the purpose of simplification, cases in which each of the management system 50 and the authentication server 40 is a single device are described as above with reference to FIG. 1. However, no limitation is intended by such an embodiment. At least one of the management system 50 and the authentication server 40 may include a plurality of devices. Alternatively, the management system 50 and the authentication server 40 may be implemented by a single system or device. Moreover, for the purpose of simplification, cases in which the communication system 1 includes the four communication terminals 10 are described as above with reference to FIG. 1. However, no limitation is intended by such an embodiment. The number of the communication terminals 10 that are provided for the communication system 1 may be two, three, or five or more. The types of the communication terminals 10 may be similar to each other, or may be different from each other as illustrated in FIG. 1.

<<Hardware Configuration>>

Next, the hardware configuration of each element of the communication system 1 is described.

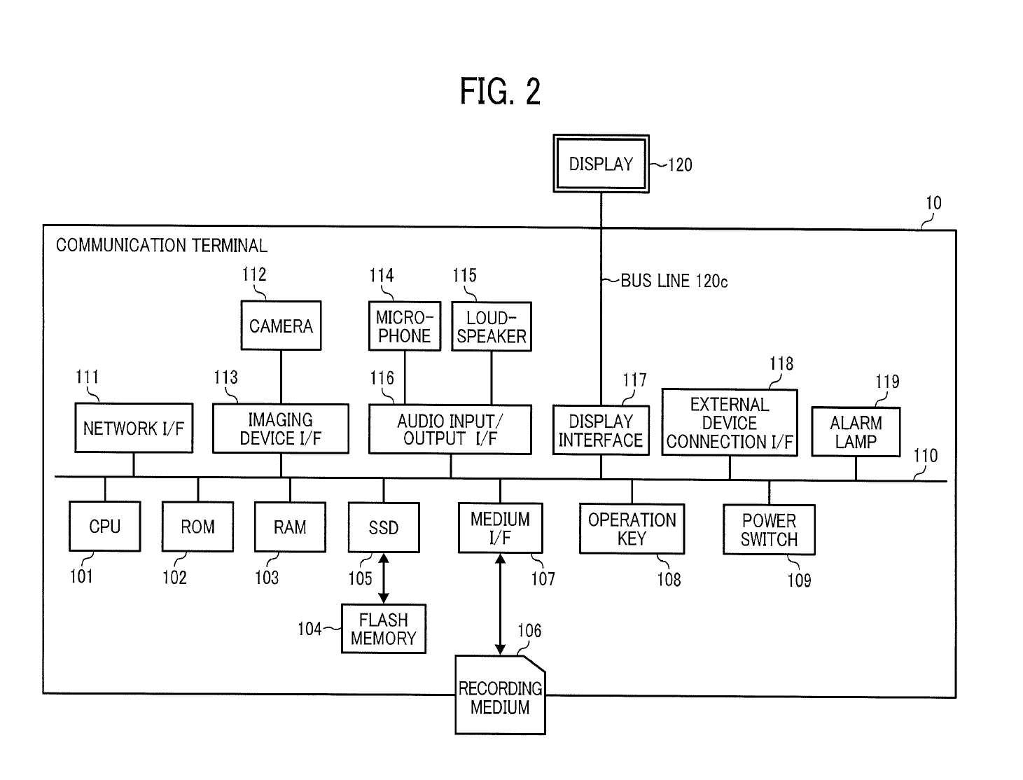

FIG. 2 is a schematic block diagram illustrating the hardware configuration of the communication terminal 10 according to the present embodiment.

The hardware configuration of the communication terminal 10 is not limited to the hardware configuration illustrated in FIG. 2 as long as the communication terminal 10 is capable of performing communication. For example, the communication terminal 10 may include an additional element that is not illustrated in FIG. 2. Alternatively, some of the elements illustrated in FIG. 2 may be omitted. Moreover, some of the elements illustrated in FIG. 2 may be, for example, an external device that can be coupled to the communication terminal 10. As illustrated in FIG. 2, the communication terminal 10 of the embodiment includes a central processing unit (CPU) 101 that controls entire operation of the communication terminal 10, a read only memory (ROM) 102 that stores a program for operating the CPU 101 such as an initial program loader (IPL), a random access memory (RAM) 103 that operates as a work area for the CPU 101, a flash memory 104 that stores various types of data, such as the terminal control program, image data, and sound data, a solid state drive (SSD) 105 that controls reading/writing of various types of data from/to the flash memory 104 under control of the CPU 101, a medium I/F 107 that controls reading/writing (storage) of data from/to a recording medium 106 such as a flash memory or integrated circuit (IC) card, the operation key 108 operated in the case of, for example, selecting a counterpart terminal of the communication terminal 10, the power switch 109 for turning on/off the power of the communication terminal 10, and a network interface (I/F) 111 for transmitting data using the communication network 2.

The terminal 10 further includes the built-in camera 112 that captures an image of a subject and obtains image data under control of the CPU 101, an imaging element I/F 113 that controls driving of the camera 112, the built-in microphone 114 that receives an audio input, the built-in loudspeaker 115 that outputs sounds, an audio input and output (input/output) interface (I/F) 116 that processes inputting/outputting of an audio signal between the microphone 114 and the loudspeaker 115 under control of the CPU 101, a display interface (I/F) 117 that transmits image data to an external display 120 under control of the CPU 101, an external device connection interface (I/F) 118 for connecting various external devices, an alarm lamp 119 for notifying of an error in functionality of the communication terminal 10, and a bus line 110 such as an address bus and a data bus for electrically connecting the above-described elements as illustrated in FIG. 2.

The display 120 is a display made of liquid crystal or organic electroluminescence (EL) that displays an image of a subject, an operation icon, or the like. The display 120 is connected to the display interface 117 via a cable 120c. The cable 120c may be an analog red green blue (RGB) (video graphic array (VGA)) signal cable, a component video cable, a high-definition multimedia interface (HDMI, registered trademark) signal cable, or a digital video interactive (DVI) signal cable.

The camera 112 includes a lens and a solid-state image sensing device that converts an image (video) of a subject to electronic data through photoelectric conversion. As the solid-state imaging element, for example, a complementary metal-oxide-semiconductor (CMOS) or a charge-coupled device (CCD) is used.

To the external device connection interface 118, an external device such as an external camera, an external microphone, and an external loudspeaker can be electrically connected, through a Universal Serial Bus (USB) cable or the like that is inserted into a connection port 1132 of the housing of a housing 1100. In cases where an external camera is connected, the external camera is driven on a priority basis and the built-in camera 112 is not driven under the control of the CPU 101. In a similar manner to the above, in the case where an external microphone is connected or an external loudspeaker is connected, the external microphone or the external loudspeaker is driven under the control of the CPU 101 on a top-priority basis over the built-in microphone 114 or the built-in loudspeaker 115.

The recording medium 106 is removable from the communication terminal 10. In addition, a nonvolatile memory that reads or writes data under the control of the CPU 101 is not limited to the flash memory 104, and for example, an electrically erasable and programmable read-only memory (EEPROM) may be used instead.

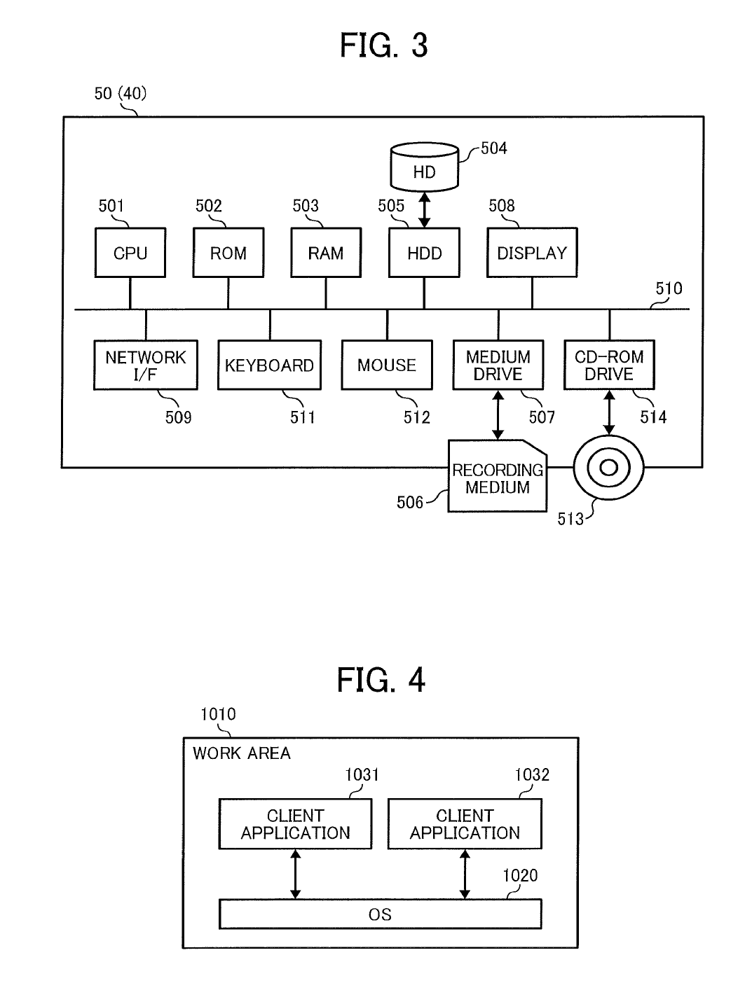

FIG. 3 is a schematic block diagram illustrating a hardware configuration of the management system 50 according to the present embodiment.

The management system 50 according to the present embodiment includes a CPU 501 that controls the entire operation of the management system 50, a ROM 502 that stores a control program for controlling the CPU 501 such as the IPL, a RAM 503 that is used as a work area for the CPU 501, a hard disk (HD) 504 that stores various kinds of data such as a control program for the management system 50, a hard disk drive (HDD) 505 that controls reading or writing of various kinds of data to or from the HD 504 under control of the CPU 501, a medium drive 507 that controls reading or writing of data from and to a recording medium 506 such as a flash memory, a display 508 that displays various kinds of information such as a cursor, a menu, a window, a character, and an image, a network interface (I/F) 509 that performs data communication using the communication network 2, a keyboard 511 that is provided with a plurality of keys for allowing a user to input, for example, characters, numerical values, and various kinds of instructions, a mouse 512 for, for example, selecting or executing various kinds of instructions, selecting an object to be processed, and for moving a cursor, a compact disc read only memory (CD-ROM) drive 514 that reads or writes various kinds of data from and to a CD-ROM 513, which is one example of removable recording medium, and a bus line 510 such as an address bus or a data bus that electrically connects various elements as above to each other as illustrated in FIG. 3. Note that the hardware configuration of the authentication server illustrated in FIG. 1 is similar to that of the management system 50, and thus the description of the hardware configuration of the authentication server 40 is omitted.

<<Software Configuration of Communication Terminal>>

FIG. 4 is a schematic block diagram illustrating a software configuration of the communication terminal 10 according to the present embodiment.

As illustrated in FIG. 4, the communication terminal 10 is installed with an operating system (OS) 1020 and client applications 1031 and 1032, and these client applications 1031 and 1032 may be deployed on a work area 1010 of the RANI 103. In FIG. 4, the communication terminal 10 is installed with the OS 1020 and the client applications 1031 and 1032.

The OS 1020 is basic software that controls entire operation of the communication terminal 10 through providing basic functions. The client applications 1031 and 1032 request the authentication server 40 to perform authentication, and sends at least one of a pub request and a sub request to the management system 50.

In FIG. 4, the communication terminal 10 is installed with at least two client applications (for example, the client applications 1031 and 1032). However, no limitation is indicated thereby, and the communication terminal 10 may be installed with one or any number of client applications. Alternatively, any desired application may be executed on the OS 1020, and the client applications may operate in such an application.

<<Functional Configuration>>

Next, the functional configuration according to the present embodiment is described.

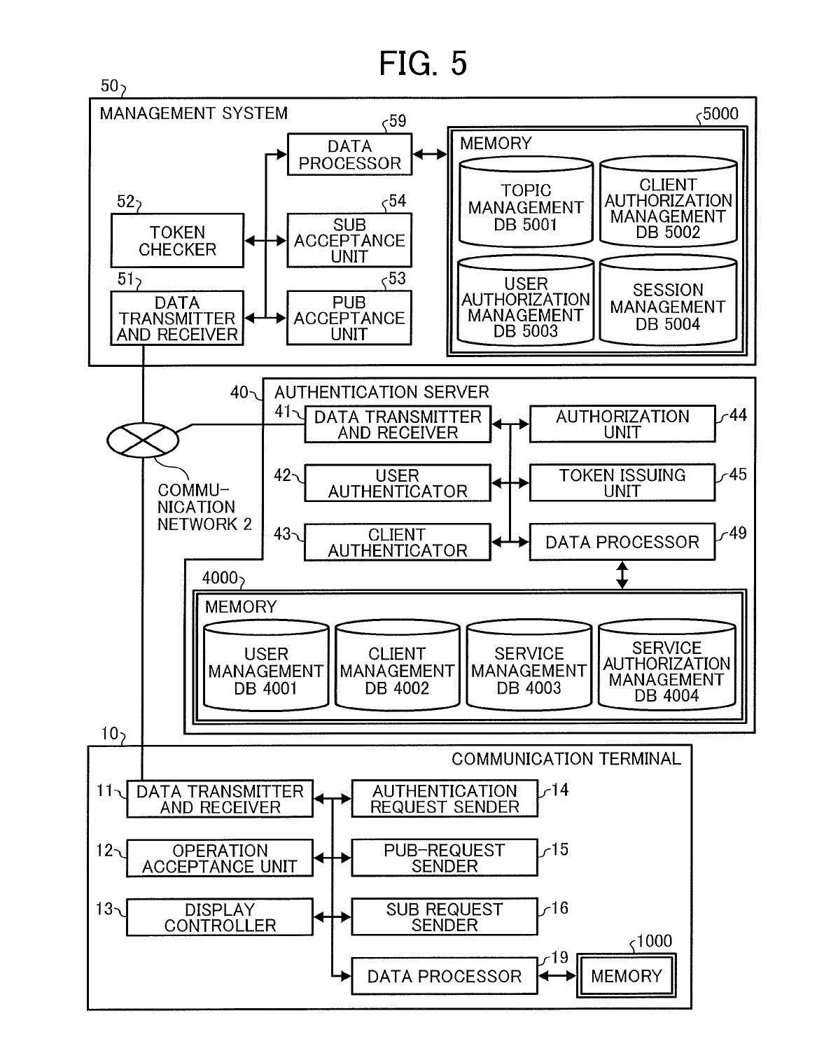

FIG. 5 is a functional block diagram of the communication terminal 10, the authentication server 40, and the management system 50, according to an embodiment of the present invention.

Note that the communication terminal 10, the authentication server 40, and the management system 50 together configure a part of the communication system 1. In FIG. 5, the communication terminal 10, the authentication server 40, and the management system 50 are connected with each other so as to perform data communication through the communication network 2.

<Functional Configuration of Communication Terminal>

The communication terminal 10 includes a data transmitter and receiver 11, an operation acceptance unit 12, a display controller 13, an authentication request sender 14, a publication (pub)-request sender 15, a subscription (sub)-request sender 16, and a data processor 19. These elements are functions that are implemented by the operation of some of the hardware components illustrated in FIG. 2 executed by the instructions from the CPU 101 in accordance with a control program expanded from the flash memory 104 onto the RAM 103. The communication terminal 10 further includes a memory 1000 configured by the ROM 102, the RAM 103, and the flash memory 104 illustrated in FIG. 2.

<Detailed Functional Configuration of Communication Terminal>

Next, the functional configuration of the communication terminal 10 is described in detail with reference to FIG. 2 and FIG. 5. In the following description of the functional configuration of the communication terminal 10, the relation of the hardware elements in FIG. 2 with the functional configuration of the communication terminal 10 will also be described.

The data transmitter and receiver 11 is implemented by the instructions from the CPU 101 and the network interface 111, each of which is illustrated in FIG. 2, and transmits or receives various kinds of data (or information) to or from, for example, a counterpart communication terminal, apparatus, and a system, through the communication network 2.

The operation acceptance unit 12 is implemented by the instructions from the CPU 101, the operation key 108, and the power switch 109, and receives various kinds of input or selection.

The display controller 13 is substantially implemented by the instructions from the CPU 101 illustrated in FIG. 2 and the display interface 117 illustrated in FIG. 2, and sends the image data that is sent from the counterpart communication terminal to the display 120 during the conversation.

The authentication request sender 14 is implemented by the instructions according to the client applications from the CPU 101 illustrated in FIG. 2, and requests the authentication server 40 to perform authentication. In cases where the communication terminal 10 is installed with a plurality of client applications, the authentication request sender 14 is generated for each one of the executed client applications in the communication terminal 10.

The pub-request sender 15 is implemented by the instructions according to the client applications from the CPU 101 illustrated in FIG. 2, and sends a pub request for a message to the management system 50. When the client application can deal with a sub but cannot deal with a pub, the pub-request sender 15 is not generated in the communication terminal 10. In cases where the communication terminal 10 is installed with a plurality of client applications that can deal with a pub, the pub-request sender 15 is generated for each one of the executed client applications in the communication terminal 10.

The sub-request sender 16 is implemented by the instructions according to the client applications from the CPU 101 illustrated in FIG. 2, and sends a sub request for a message to the management system 50. When the client application can deal with a pub but cannot deal with a sub, the sub-request sender 16 is not generated in the communication terminal 10. In cases where the communication terminal 10 is installed with a plurality of client applications that can deal with a sub, the sub-request sender 16 is generated for each one of the executed client applications in the communication terminal 10.

The data processor 19 is substantially implemented by the instructions from the CPU 101 and the SSD 105 each of which is illustrated in FIG. 2. Alternatively, the data processor 19 is substantially implemented by the instructions from the CPU 101 illustrated in FIG. 2, and performs processing to store various types of data in the memory 1000 or read various types of data stored in the memory 1000.

<Functional Configuration of Authentication Server>

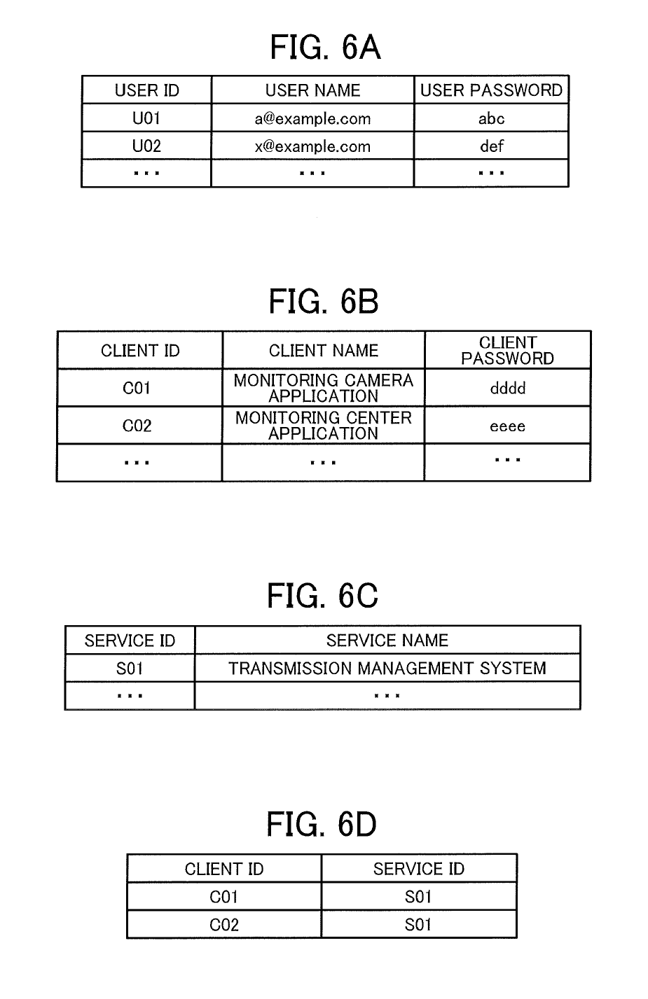

As illustrated in FIG. 6, the authentication server 40 includes a data transmitter and receiver 41, a user authenticator 42, a client authenticator 43, an authorization unit 44, a token issuing unit 45, and a data processor 49. These units are functions implemented by or caused to function by operating some of the elements illustrated in FIG. 3 under the control of the instructions from the CPU 501. Note also that such instructions from the CPU 501 are made in accordance with a program for the authentication server 40 expanded from the HD 504 to the RAM 503. The authentication server 40 also includes a memory 4000 that is configured by the HD 504 illustrated in FIG. 3.

<User Management Table>

FIG. 6A is a diagram illustrating an example data structure of a user management table, according to the present embodiment.

In the memory 4000, as illustrated in FIG. 5, a user management database (DB) 4001 that is made of a user management table is stored. In the authentication management table, for each user ID (identifier, identification), the user name and the password are stored in association with each other.

<Client Management Table>

FIG. 6B is a diagram illustrating an example data structure of a client management table, according to the present embodiment.

In the memory 4000, as illustrated in FIG. 5, a client management database (DB) 4002 that is made of a client management table is stored. In the authentication management table, for each client ID, the client name and the password are stored in association with each other. A monitoring camera application illustrated in FIG. 6B is a client application that is used by the communication terminal 10 to request the management system 50 to publish the image data of captured images as a message. A monitoring center application illustrated in FIG. 6B is a client application that is used to request the management system 50 to subscribe to the image data of captured images as a message. Note also that the monitoring center application is not only a client application that is used to request the management system 50 to subscribe to the image data but also is a server application that accepts a request for the management of captured images from the monitoring camera application.

<Service Management Table>

FIG. 6C is a diagram illustrating an example data structure of a service management table, according to the present embodiment.

In the memory 4000, as illustrated in FIG. 5, a service management database (DB) 4003 that is made of a service management table is stored. The service management table stores the service name in association with each service ID. According to the present embodiment, the service “transmission management system” that is identified by service ID “S01” is the management system 50. The right of the management system 50 to use the functions of pub/sub is the resource. Note also that the pub/sub service with the use of the management system 50 serves as a scope of authorization in the protocol of OAuth 2.0. Note also that the management system 50 serves as a resource server.

<Service Authorization Management Table>

FIG. 6D is a diagram illustrating an example data structure of a service authorization management table, according to the present embodiment.

In the memory 4000, as illustrated in FIG. 5, a service authorization management database (DB) 4004 that is made of a service authorization management table is stored. The service authorization management table stores the service ID in association with each client ID. Accordingly, in the service authorization management table, what client can access what service can be managed. The service authorization management table illustrated in FIG. 6D indicates that the chat application identified by the client ID “C01” can access the transmission management system identified by the service ID “S01”, i.e., the management system 50.

<Detailed Functional Configuration of Authentication Server>

The data transmitter and receiver 41 is implemented by the instructions from the CPU 501 and the network interface 509, each of which is illustrated in FIG. 3, and transmits or receives various kinds of data (or information) to or from a counterpart communication terminal, apparatus, a system, or the like through the communication network 2.

The user authenticator 42 is implemented by the instructions from the CPU 501 illustrated in FIG. 3, and performs user authentication in response to a request from a client.

The client authenticator 43 is implemented by the instructions from the CPU 501 illustrated in FIG. 3, and performs client authentication in response to a request from a client.

The authorization unit 44 is implemented by the instructions from the CPU 501 illustrated in FIG. 3, and performs authorization by specifying the access right of a client to service.

The token issuing unit 45 is implemented by the instructions from the CPU 501 illustrated in FIG. 3, and issues an authorizing token to be used in the service that a client wishes to access.

The data processor 49 is substantially implemented by the instructions from the CPU 501 and the HDD 505 each of which is illustrated in FIG. 3. Alternatively, the data processor 49 is implemented by the instructions from the CPU 501 illustrated in FIG. 3. The data processor 49 performs processing to store various types of data in the memory 4000 or read various types of data stored in the memory 4000.

<Functional Configuration of Management System>

The management system 50 includes a data transmitter and receiver 51, a token checker 52, a pub acceptance unit 53, a sub acceptance unit 54, and a data processor 59. These units are functions implemented by or caused to function by operating some of the elements illustrated in FIG. 3 under the control of the instructions from the CPU 501. Note also that such instructions from the CPU 501 are made in accordance with a program for the management system 50 expanded from the HD 504 to the RANI 503. The management system 50 also includes a memory 5000 that is configured by the HD 504 illustrated in FIG. 3.

<Topic Management Table>

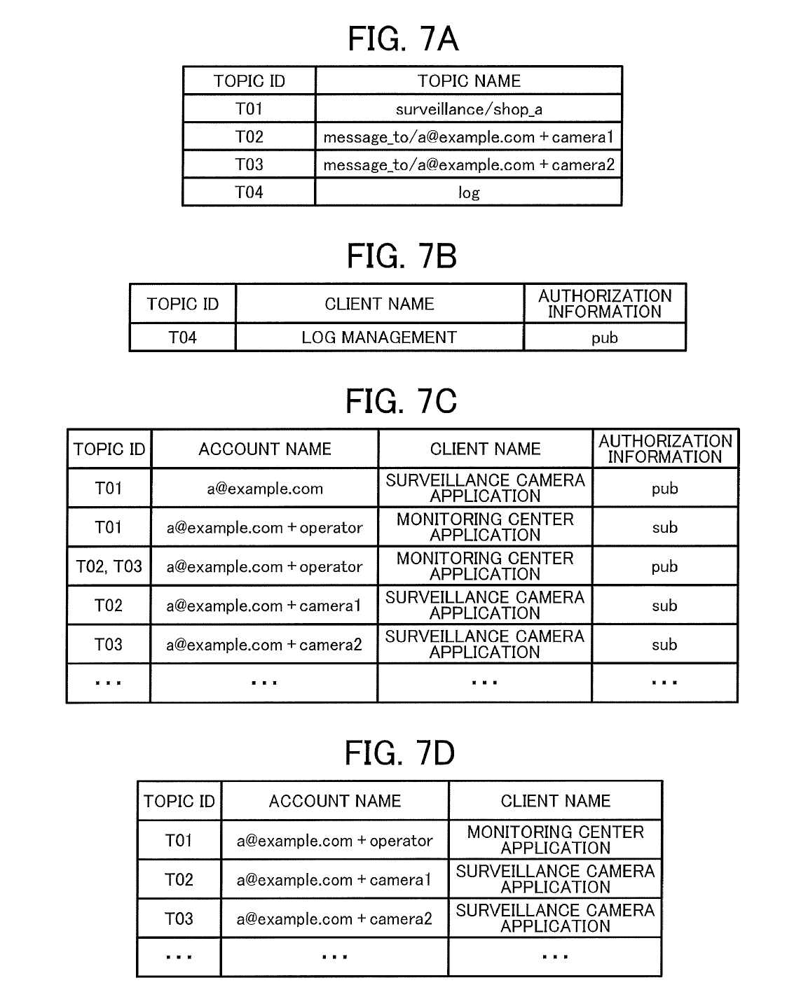

FIG. 7A is a diagram depicting a topic management table according to the present embodiment.

In the memory 5000, as illustrated in FIG. 5, a topic management database (DB) 5001 that is made of a topic management table is stored. In the topic management table, topic ID is stored in association with each topic name. A topic is an attribute associated with a message. Once a client application specifies a topic and sends a sub request, the management system 50 sends a message that is published in association with the specified topic to the client application of the request sender.

<Client Authorization Management Table>

FIG. 7B is a diagram illustrating an example data structure of a client authorization management table, according to the present embodiment.

In the memory 5000, as illustrated in FIG. 5, a client authorization management database (DB) 5002 that is made of client authorization management table is stored. The client authorization management table stores, for each topic ID, the client name and the authorization information in association with each other. The authorization information indicates whether or not to have the right to publish or subscribe to.

<User Authorization Management Table>

FIG. 7C is a diagram illustrating an example data structure of a user authorization management table, according to the present embodiment.

In the memory 5000, as illustrated in FIG. 5, a user authorization management database (DB) 5003 that is made of a user authorization management table is stored. The user authorization management table stores, for each topic ID, the account name, the client name, and the authorization information in association with each other. The authorization information indicates whether or not to have the right to publish or subscribe to. In the present embodiment, authorization is performed on an account name-by-account name basis, and the account name is represented by the user name or the user name with the additional information of the terminal name. In the present embodiment, the user name is represented by a mail address format standardized by the request for comments (RFC) of the Internet Engineering Task Force (IETF).

<Session Management Table>

FIG. 7D is a diagram depicting a session management table according to the present embodiment.

In the memory 5000, as illustrated in FIG. 5, a session management database (DB) 5004 that is made of a session management table is stored. The session management table stores the topic ID, the account name, and the client name in association with each other. The session management table indicates a message of what topic is being subscribed to by the account that is currently executing a session. Accordingly, the management system 50 can determine to what account a message is to be sent when a pub request for a message on the topic is received.

<Detailed Functional Configuration of Management System>

Next, the functional configuration of the management system 50 is described in detail. In the following description of the functional configuration of the management system 50, the relation between the hardware configuration of FIG. 3 and the functional configuration of the management system 50 illustrated in FIG. 5 will also be described.

The data transmitter and receiver 51 is implemented by the instructions from the CPU 501 and the network interface 509, each of which is illustrated in FIG. 3, and transmits or receives various kinds of data (or information) to or from another communication terminal, apparatus, or system, through the communication network 2.

The token checker 52 is implemented by the instructions from the CPU 501 illustrated in FIG. 3, and checks an authorizing token included in the login request of the communication terminal 10.

The pub acceptance unit 53 is implemented by the instructions from the CPU 501 illustrated in FIG. 3, and receives a pub request from the client.

The sub acceptance unit 54 is implemented by the instructions from the CPU 501 illustrated in FIG. 3, and receives a sub request from the client.

The data processor 59 is substantially implemented by the instructions from the CPU 501 and the HDD 505 each of which is illustrated in FIG. 3. Alternatively, the data processor 59 is implemented by the instructions from the CPU 501 illustrated in FIG. 3. The data processor 59 performs processing to store various types of data in the memory 5000 or read various types of data stored in the memory 5000.

<Operation>

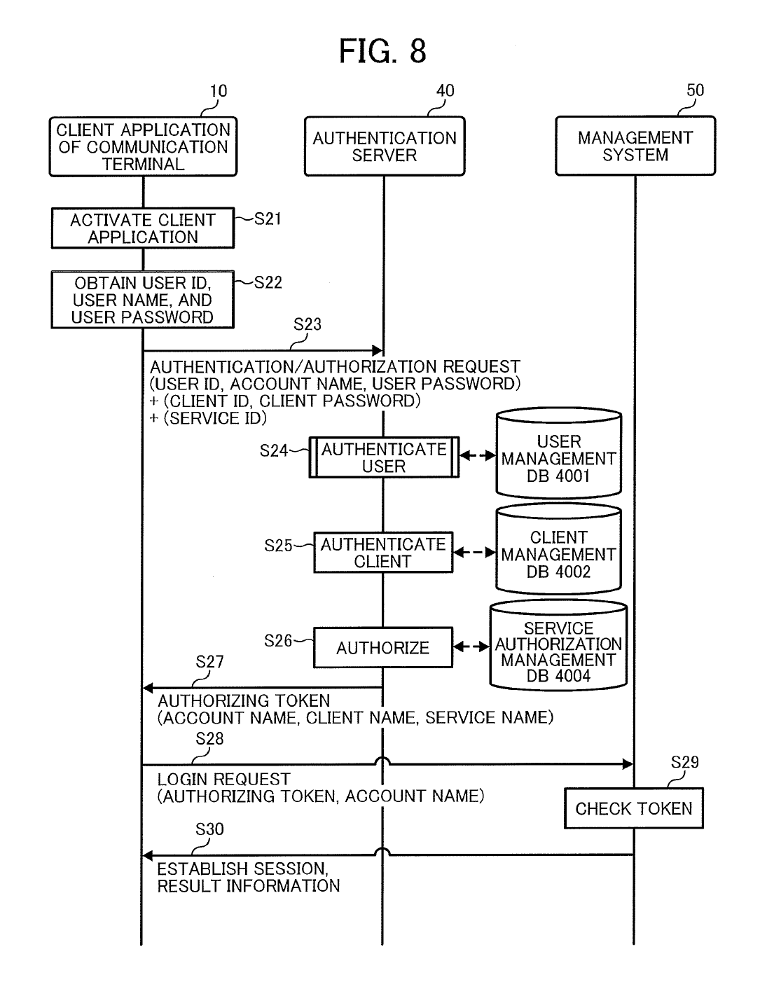

Next, the operation of the communication terminal 10, the authentication server 40, and the management system 50 that together configure the communication system 1 is described. Firstly, the authentication processes according to the present embodiment are described with reference to FIG. 8.

FIG. 8 is a sequence diagram illustrating the authentication processes according to the present embodiment.

In the processes described below, the processes of the client authentication of the communication terminal 10 in addition to the user authentication of the communication terminal according to the present embodiment are described. However, at least as long as the user authentication is performed, no limitation is intended by the present embodiment described below.

Once a desired client application that is installed in the communication terminal 10 is activated (step S21), the activated client application starts the following processes. The client application of the communication terminal 10 obtains user ID, a user name, and a user password (step S22). No limitation is intended, but the obtaining method may be, for example, a method in which the operation acceptance unit 12 accepts an input of user ID and a user password, and a method in which the data processor 19 reads user ID and a password that are stored in the memory 1000.

The authentication request sender 14 of the communication terminal 10 sends an authentication/authorization request to the authentication server 40 through the data transmitter and receiver 11 (step S23). The authentication/authorization request includes a request to authenticate a user, a request to authenticate a client, and a request to authorize the use of service.

The user authentication request includes the user ID and the user password that are obtained in the step S22 as well as the account name of the account that corresponds to the user and the communication terminal 10. In the present embodiment, the account name is represented by the user name obtained in the step S22 with the additional information of the terminal name of the communication terminal 10. In the following description, the terminal names of the communication terminal 10a, the communication terminal 10b, and the communication terminal 10c are referred to as “camera1”, “camera2, and “operator”, respectively. Note also that the terminal names may be ones stored in the memory 1000 of the communication terminal 10 or may be ones received by the operation acceptance unit 12 of the communication terminal 10.

As described above, the user name is represented by a mail address format standardized by the RFC of the IETF. Hereinafter, a user in common with the communication terminals 10a, 10b, and 10c is referred to as a user a, and the user name of the user “a” is referred to as “a@example.com”. A user name and a terminal name are separated by a predetermined separator. As an arrangement in advance, a character that can uniquely separate a user name from a terminal name is set as a separator. For example, when the user name is in an email address format, “+” cannot be used for the domain name after “@”, and thus “+” is used as a separator. The data transmitter and receiver 11 of the communication terminal 10 adds the separator and the terminal name to the user name obtained in the step S22 to create an account name. For example, the account name that is generated when the user “a” sends an authentication/authorization request using the communication terminal 10a is “a@example.com+camera1”.

The client authentication request includes the client ID and the client password of the activated client. The client ID and the client password may be stored in advance in the memory 1000. The data transmitter and receiver 11 reads the client ID and the client password stored in the memory 1000, and incorporate the read client ID and client password into the to-be-sent client authentication request.

A request to authorize the use of service includes service ID as a scope of the service to be used. In the following description, it is assumed that the service ID included in the request to authorize the use of service is “S01” that indicates the management system 50.

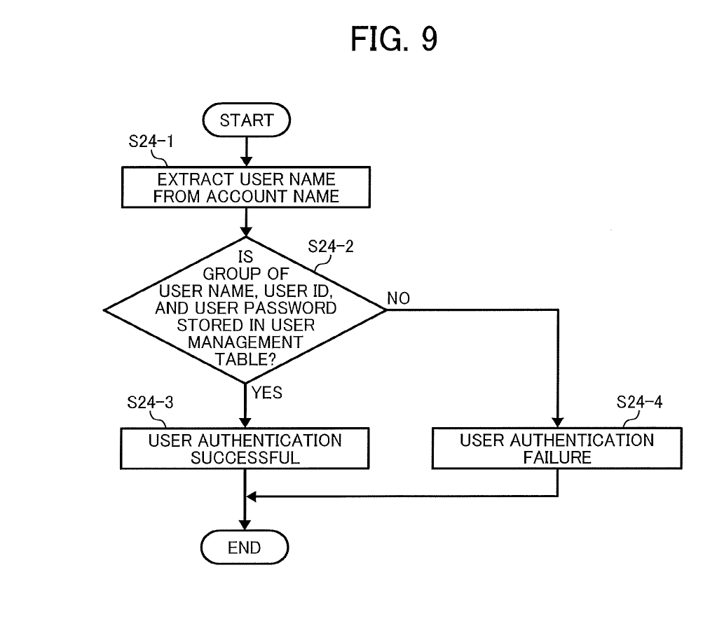

The data transmitter and receiver 41 of the authentication server 40 receives an authentication/authorization request that includes a user authentication request, a client authentication request, and a request to authorize the use of service, each of which is sent from the communication terminal 10. The user authenticator 42 authenticates the user in response to the reception of the authentication/authorization request (step S24). With reference to FIG. 9, the processes in the step S24 are described in detail.

FIG. 9 is a flowchart of user authentication processes according to the present embodiment.

The user authenticator 42 extracts a user name from the account name included in the user authentication request received in the step S23 (step S24-1). For example, the user authenticator 42 extracts the section before the separator “+”, i.e., the user name “a@example.com”, from the account name “a@example.com+camera1” included in the user authentication request. Note that a method of extracting a user name from an account name is not limited to the embodiment described above, and it is satisfactory as long as the method meets a rule that the communication terminal 10 creates an account name. For example, in cases where an account name is created with a rule that the user name is to be included in the first three letters, the user authenticator 42 extracts the first three letters from the account name as the user name. Alternatively, in cases where an account name is created with a rule that the user name and the terminal name are represented in uppercase and lower-case, respectively, the user authenticator 42 extracts the letters in uppercase from the account name as the user name. After the extraction processes as described above are completed, the user authenticator 42 authenticates the user using the extracted user name as an authentication name. In such a configuration, the user authenticator 42 determines whether a group of the extracted user name, the user ID and the user password included in the authentication request is stored in the user management table (see FIG. 6A) (step S24-2).

When the group of the user name, the user ID, and the user password is stored in the user management table (“YES” in the step S24-2), the user authenticator 42 successfully authenticates the user (step S24-3). For example, when the user name, the user ID included in the user authentication request, and the user password are “a@example.com”, “U01”, and “abc”, respectively, a group of these items of information are stored in the user management table and thus the user is authenticated successfully. When the group of the user name, the user ID, and the user password is not stored in the user management table (“NO” in the step S24-2), the user authenticator 42 fails to authenticate the user (step S24-4).

When the user authentication is successfully completed, the client authenticator 43 of the authentication server 40 determines whether or not a pair of the client ID and the client password included in the authentication request is stored in the client management table (see FIG. 6B). When the pair of the client ID and the client password included in the client authentication request is stored in the client management table, the client authenticator 43 successfully authenticates the client (step S25). When the pair of the client ID and the client password included in the client authentication request is not stored in the client management table, the client authenticator 43 fails to authenticate the client.

When the client is successfully authenticated, the authorization unit 44 of the authentication server 40 determines whether a pair of the client ID and the service ID included in the client authentication request is stored in the service authorization management table (see FIG. 6D). When the pair of the client ID and the service ID is stored in the service authorization management table, the authorization unit 44 successfully authorizes the use of service (step S26). When the pair of the client ID and the service ID is not stored in the service authorization management table, the authorization unit 44 fails to authorize the use of service.

When there is a failure in at least one of the user authentication, the client authentication, and the authorization of the use of service, the data transmitter and receiver 41 sends an error message indicating a failure in authentication or authorization to the request sender communication terminal 10.

When all the user authentication, the client authentication, and the authorization of the use of service are successful, the token issuing unit 45 of the authentication server 40 issues an authorizing token that indicates that the communication terminal 10 that has sent an authentication request is authorized to access the management system 50. In such a configuration, the token issuing unit 45 incorporates the account name included in the user authentication request, the client name that corresponds to the client ID included in the client authentication request, the service name that corresponds to the service ID included in the request to authorize the use of service, and the expiration of the authorizing token into the authorizing token.

In the communication system 1, authentication and authorization can be performed with a protocol such as the OAuth 2.0 and the OpenID Connect. In such cases, a method of exchanging the authentication information such as user ID and a user password and the contents of the authorizing token are determined by the specification of a protocol such as the OAuth 2.0 and the OpenID Connect. In this configuration, the token may be a JSON Web Token (JWT). In order to ensure that the authorizing token is not tampered with in the path, the token issuing unit 45 may digitally sign the authorizing token using a secret key. The secret key may be implemented using the RSA (Rivest, Shamir, and Adleman) cryptosystem. Note also that the digital signature may be implemented using a public key cryptography such as the hash-based message authentication code (HMAC). The management system 50 that uses the authorizing token checks the digital signature using a public key or a secret key depending on whether the authorizing token is digitally signed using a secret key or a public key. The digital signature may be implemented using a known standard, for example, the JSON Web Signature (JWS). The authorizing token may be encoded by using, for example, the JSON Web Encryption (JWE), where appropriate.

The data transmitter and receiver 41 sends the issued authorizing token and result information indicating that the authentication and authorization were successful to the communication terminal 10 (step S27). The data transmitter and receiver 11 of the communication terminal 10 receives the authorizing token and the result information sent from the authentication server. Subsequently, the data transmitter and receiver 11 of the communication terminal 10 sends a login request that includes the received authorizing token and the account name to the management system 50 (step S28). The account name that is included in the login request is identical with the account name included in the authentication/authorization request that was sent to the authentication server 40 in the step S23. For example, the account name that is used when the user “a” sends a login request using the communication terminal 10a is “a@example.com+camera1”.

The data transmitter and receiver 51 of the management system 50 receives the login request sent from the communication terminal 10. The token checker 52 of the management system 50 checks an authorizing token included in the login request (step S29). In this process, the token checker 52 checks whether the authorizing token is valid. A method of checking an authorizing token is selected as appropriate according to the format of the token or digital signature in the token checking application programming interface (API) provided by the authentication server 40. For example, an authorizing token may be checked using signature verification that uses a common key and a public key. As the authorizing token according to the present embodiment includes expiration data, the token checker 52 may verify the authorizing token according to expiration data. Moreover, as the authorizing token according to the present embodiment includes service ID, the token checker 52 may verify the authorizing token when the service identified by the service ID indicates the management system 50. When the authorizing token is determined to be invalid as a result of the check, the token checker 52 rejects the login request from the request sender to the management system 50. When the authorizing token is valid, the token checker 52 determines whether or not to authorize the login request from the request sender. In such cases, the token checker 52 checks whether the account name included in the authorizing token matches the account name sent together with authorizing token in the login request.

When the account names do not match as a result of the check, the token checker 52 rejects the login request from the request sender to the management system 50. When the account names match, the token checker 52 authorizes the login request from the request sender to the management system 50. In such cases, the data transmitter and receiver 51 of the management system 50 sends result information indicating the login was successful to the login request sender (i.e., the communication terminal 10) (step S30). Accordingly, the management system 50 establishes a communication session with the communication terminal 10.

Once the session is established, the management system 50 stores in the memory 5000 the account name and the client name included in the authorizing token, the IP address of the communication terminal 10 that has sent the login request, or the like, in association with each other. Due to this configuration, the management system 50 can figure out the account name of the request sender and the client name, without the communication terminal's sending the account name and the client name to the management system 50 every time the logged-in communication terminal 10 sends data to the management system 50.

When the same user “a” uses different communication terminals 10, the processes in the steps S21 to S30 as above are performed for each one of these communication terminals 10. For example, the monitoring camera applications of the communication terminal 10a and the communication terminal 10b that the user “a” uses send the account names “a@example.com+camera1, a@example.com+camera2” and the client ID “C01” to the authentication server 40 to request for authentication. On the other hand, the monitoring center application of the communication terminal 10c that the user “a” uses send the account name “a@example.com+operator” and the client ID “C02” to the authentication server 40 to request for authentication. In such cases, the authentication server 40 authenticates the single user name “a@example.com” as an authentication name, and the management system 50 uses the account name where the terminal names “camera1, camera2, operator” are added to the user name “a@example.com” to perform authorization on an account-by-account basis.

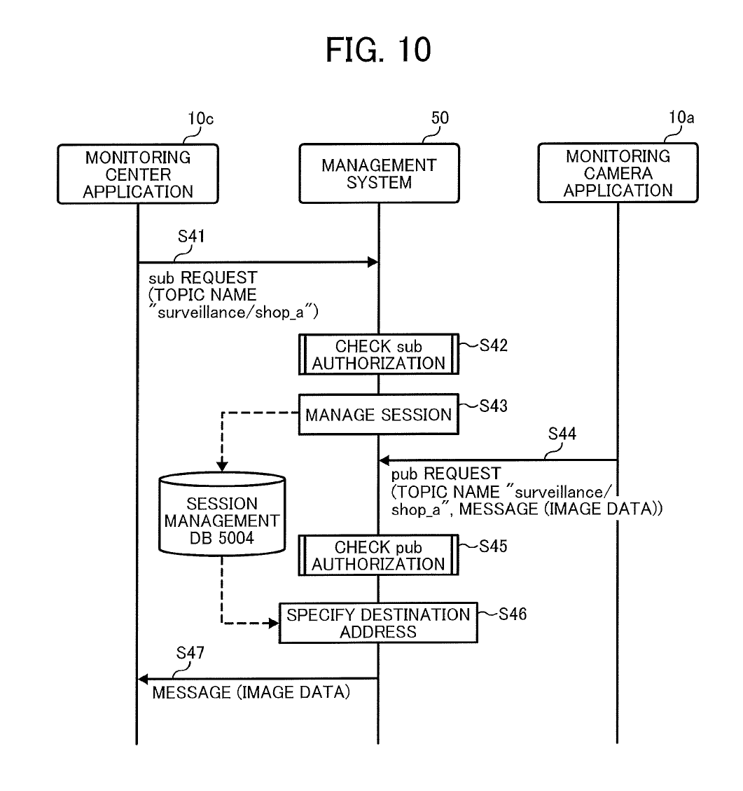

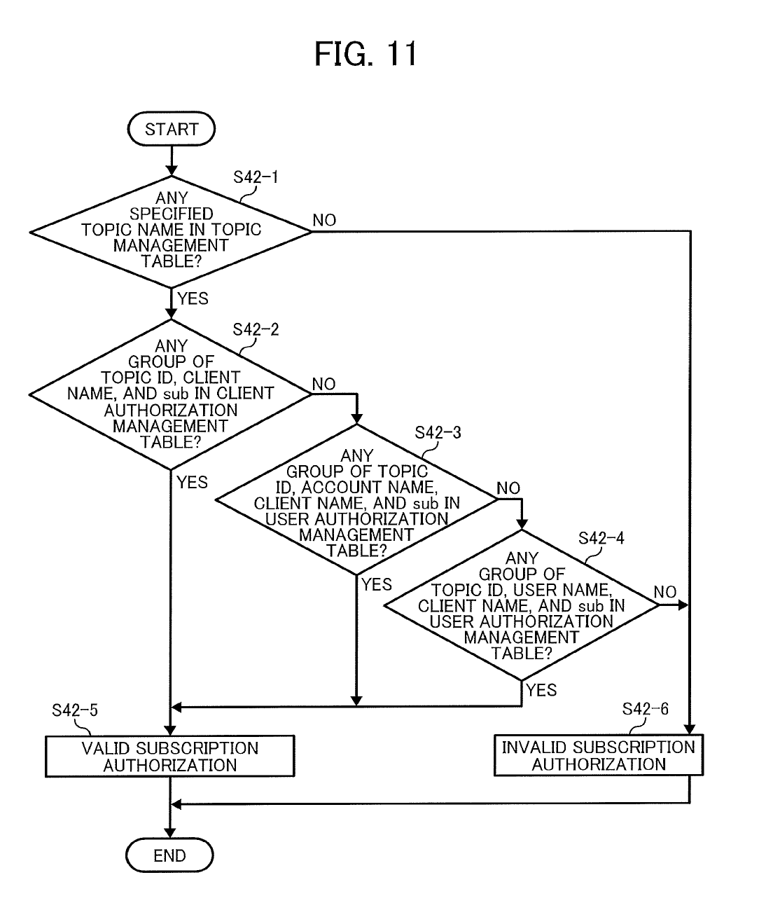

Next, the processes in which a message is sent among the multiple communication terminals 10 are described with reference to FIG. 10.

FIG. 10 is a sequence diagram illustrating the processes of sending a message between the communication terminal 10a and the communication terminal 10c, according to the present embodiment.

Note also that the communication terminal 10a is a camera with a communication facility and is installed in a store or establishment. Note also that the communication terminal 10c according to the present embodiment is a personal computer (PC) with a communication facility and is installed in an office. The communication terminal 10a and the communication terminal 10c are used by the user “a” who is the target to be authenticated in common. In other words, in the processes in the steps S21 to S30 as above are performed, the monitoring camera application of the communication terminal 10a and the monitoring center application of the communication terminal 10c sends the account names “a@example.com+camera1, a@example.com+operator” to the management system 50, respectively, the authentication/authorization requests are authenticated and authorized, respectively.

The sub-request sender 16 of the communication terminal 10c sends a sub request to the management system 50 in order to receive the images captured by the monitoring camera application (step S41). The sub request includes the topic name “surveillance/shop_a” related to the images captured by the monitoring camera application.

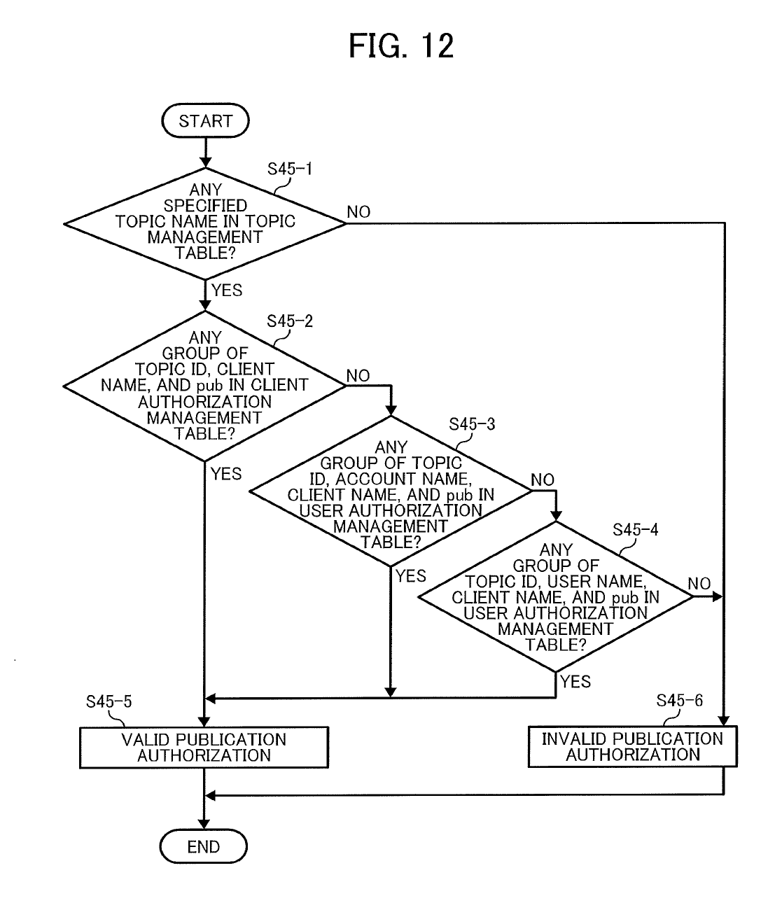

The data transmitter and receiver 51 of the management system 50 receives the sub request sent from the communication terminal 10c. The sub acceptance unit 54 of the management system 50 determines whether the account of the sub-request sender has the authority to subscribe to the topic with the topic name “surveillance/shop_a” included in the sub request (step S42). With reference to FIG. 11, the processes in the step S42 are described in detail.

FIG. 11 is a flowchart of the processes of determining whether or not each communication terminal has the authority to subscribe to a message, according to the present embodiment.

Firstly, the sub acceptance unit 54 determines whether or not a topic name “surveillance/shop_a” is included in the sub request is stored in the topic management table (see FIG. 7A) (step S42-1). When it is determined that the topic name included in the sub request is not stored in the topic management table (“NO” in the step S42-1), the sub acceptance unit 54 determines that the sub-request sender does not have the authority to subscribe to the topic included in the sub request (step S42-6).

When it is determined that the topic name included in the sub request is stored in the topic management table (“YES” in the step S42-1), the sub acceptance unit 54 determines whether or not a group of the topic ID “T01” that corresponds to the topic name “surveillance/shop_a” included in the sub request, the client name “monitoring center application” of the sub-request sender, and the authorization information “sub” is stored in the client authorization management table (step S42-2). Note that the authorization information “sub” indicates the presence of sub authorization.

When the sub acceptance unit 54 determines that a group of the topic ID included in the sub request, the client name of the sub-request sender, and the authorization information “sub”, indicating the presence of sub authorization, is stored in the client authorization management table (“YES” in the step S42-2), the sub acceptance unit 54 determines that the sub-request sender has the authority to subscribe to the topic included in the sub request (step S42-5). In the step S42-2, as long as the request is sent from a specific client, regardless of the account, the sub acceptance unit 54 determines whether the sub-request sender has the authority to subscribe to such a topic that can be subscribed to.

When it is determined to be “NO” in the step S42-2, the sub acceptance unit 54 determines whether a group of the topic ID “T01” of the topic name included in the sub request, the account name “a@example.com+operator” of the sub-request sender, the client name “monitoring center application” of the sub-request sender, and the authorization information “sub” is stored in the user authorization management table (step S42-3). Note that the authorization information “sub” indicates the presence of sub authorization.

When the sub acceptance unit 54 determines that a group of the topic ID of the topic name included in the sub request, the account name of the sub-request sender, the client name of the sub-request sender, and the authorization information “sub”, indicating the presence of sub authorization, is stored in the user authorization management table (“YES” in step S42-3), the sub acceptance unit 54 determines that the sub-request sender has the authority to subscribe to the topic included in the sub request (step S42-5).

When the sub acceptance unit 54 determines that a group of the topic ID of the topic name included in the sub request, the account name of the sub-request sender, the client name of the sub-request sender, and the authorization information “sub”, indicating the presence of sub authorization, is not stored in the user authorization management table (“NO” in step S42-3), the sub acceptance unit 54 determines whether or not a group of the topic ID of the topic name included in the sub request, the user name of the sub-request sender, the client name of the sub-request sender, and the authorization information “sub”, indicating the presence of sub authorization, is stored in the user authorization management table (step S42-4). Note also that sub acceptance unit 54 performs the processes as described above upon extracting the letters before the separator “+” from the account name of the sub-request sender as the user name.

When the sub acceptance unit 54 determines that a group of the topic ID of the topic name included in the sub request, the user name of the sub-request sender, the client name of the sub-request sender, and the authorization information “sub”, indicating the presence of sub authorization, is not stored in the user authorization management table (“NO” in step S42-4), the sub acceptance unit 54 determines that the sub-request sender does not have the authority to subscribe to the topic included in the sub request (step S42-6).

When the sub acceptance unit 54 determines that a group of the topic ID of the topic name included in the sub request, the user name of the sub-request sender, the client name of the sub-request sender, and the authorization information “sub”, indicating the presence of sub authorization, is stored in the user authorization management table (“YES” in step S42-4), the sub acceptance unit 54 determines that the sub-request sender has the authority to subscribe to the topic included in the sub request (step S42-5). In the processes in the step S42-4, as long as the request is sent from a specific user, regardless of the account, the sub acceptance unit 54 determines whether the sub-request sender has the authority to subscribe to such a topic that can be subscribed to.

When it is determined in the step S42-5 that the sub-request sender has sub authority, the sub acceptance unit 54 registers the account name “a@example.com+operator” of sub-request sender, the client name “monitoring center application”, and the topic ID “T01” of the topic name included in the sub request in association with the session management table (see FIG. 7D) (step S43).

On the other hand, the pub-request sender 15 of the communication terminal 10a sends a pub request to the management system 50 in order to send a message to the monitoring center application of the communication terminal 10c (step S44). The pub request includes the topic name “surveillance/shop_a” related to the images captured by the monitoring camera application, and the image data captured by the local communication terminal as a message.

The data transmitter and receiver 51 of the management system 50 receives the pub request sent from the communication terminal 10a. The pub acceptance unit 53 of the management system 50 determines whether the account of the pub-request sender has the authority to publish the topic with the topic name “surveillance/shop_a” included in the pub request (step S45). With reference to FIG. 12, the processes in the step S45 are described in detail.

FIG. 12 is a flowchart of the processes of determining whether or not each communication terminal has the authority to publish a message, according to the present embodiment.

Firstly, the pub acceptance unit 53 determines whether or not a topic name “surveillance/shop_a” is included in the pub request is stored in the topic management table (see FIG. 7A) (step S45-1). When it is determined that the topic name included in the pub request is not stored in the topic management table (“NO” in the step S45-1), the pub acceptance unit 53 determines that the pub-request sender does not have the authority to publish the topic included in the pub request (step S45-6).

When it is determined that the topic name included in the pub request is stored in the topic management table (“YES” in the step S45-1), the pub acceptance unit 53 determines whether or not a group of the topic ID “T01” that corresponds to the topic name “surveillance/shop_a” included in the pub request, the client name “monitoring camera application” of the pub-request sender, and the authorization information “pub” is stored in the client authorization management table (step S45-2). Note that the authorization information “pub” indicates the presence of pub authorization.

When the pub acceptance unit 53 determines that a group of the topic ID included in the pub request, the client name of the pub-request sender, and the authorization information “pub”, indicating the presence of pub authorization, is stored in the client authorization management table (“YES” in the step S45-2), the pub acceptance unit 53 determines that the pub-request sender has the authority to subscribe to the topic included in the pub request (step S45-5). In the step S45-2, as long as the request is sent from a specific client, regardless of the account, the pub acceptance unit 53 determines whether the pub-request sender has the authority to publish such a publishable topic.

When it is determined to be “NO” in the step S45-2, the pub acceptance unit 53 determines whether a group of the topic ID “T01” of the topic name included in the pub request, the account name “a@example.com+camera1” of the pub-request sender, the client name “monitoring camera application” of the pub-request sender, and the authorization information “pub” indicating the presence of pub authorization is stored in the user authorization management table (step S45-3).

When the pub acceptance unit 53 determines that a group of the topic ID of a topic included in the pub request, the account name of the pub-request sender, the client name of the pub-request sender, and the authorization information “pub”, indicating the presence of pub authorization, is stored in the user authorization management table (“YES” in step S45-3), the pub acceptance unit 53 determines that the pub-request sender has the authority to publish the topic included in the pub request (step S45-5).

When the pub acceptance unit 53 determines that a group of the topic ID of a topic included in the pub request, the account name of the pub-request sender, the client name of the pub-request sender, and the authorization information “pub”, indicating the presence of pub authorization, is not stored in the user authorization management table (“NO” in step S45-3), the pub acceptance unit 53 determines whether a group of the topic ID “T01” of the topic name included in the pub request, the user name “a@example.com” of the pub-request sender, the client name “monitoring camera application” of the pub-request sender, and the authorization information “pub” indicating the presence of pub authorization is stored in the user authorization management table (step S45-4). Note also that pub acceptance unit 53 performs the processes as described above upon extracting the letters before the separator “+” from the account name of the pub-request sender as the user name.

When the pub acceptance unit 53 determines that a group of the topic ID of a topic included in the pub request, the user name of the pub-request sender, the client name of the pub-request sender, and the authorization information “pub”, indicating the presence of pub authorization, is not stored in the user authorization management table (“NO” in step S45-4), the pub acceptance unit 53 determines that the pub-request sender does not have the authority to publish the topic included in the pub request (step S45-6).

When the pub acceptance unit 53 determines that a group of the topic ID of a topic included in the pub request, the user name of the pub-request sender, the client name of the pub-request sender, and the authorization information “pub”, indicating the presence of pub authorization, is stored in the user authorization management table (“YES” in step S45-4), the pub acceptance unit 53 determines that the pub-request sender has the authority to subscribe to the topic specified in pub request (step S45-5). When it is determined in the step S45-4 that the request is sent from a specific user, regardless of the account, the pub acceptance unit 53 determines whether the pub-request sender has the authority to publish such a publishable topic.

When it is determined in the step S45-5 that the pub-request sender has pub authority, the pub acceptance unit 53 uses the topic ID “T01” of the topic with the topic name “surveillance/shop_a” included in the pub request as a search key to search the session management table, and obtains a pair of the corresponding account name and client name, i.e., “a@example.com+operator” and “monitoring center application” (step S46). Accordingly, the pub acceptance unit 53 identifies, as a destination of a message, the monitoring center application of the communication terminal 10c that logged in the management system 50 with the account name “a@example.com+operator”.

The data transmitter and receiver 51 sends the message included in the pub request, i.e., the image data and the account name “a@example.com+camera1” of the pub-request sender, to the monitoring center application of the communication terminal 10c identified as above. Accordingly, the data transmitter and receiver 11 of the communication terminal 10c receives the image data as a message and the account name of the pub-request sender.

The management system 50 may store a message related to the pub request in the memory 5000. By so doing, when a client that is not connected to the management system 50 at the time of pub request is later connected to the management system 50, the management system 50 can send a message stored in the memory 5000 to that client.

<<Modification A of Example Embodiment>>

Next, a modification A of the embodiments of the present disclosure is described. In particular, differences in configuration from the embodiments as described above are described.

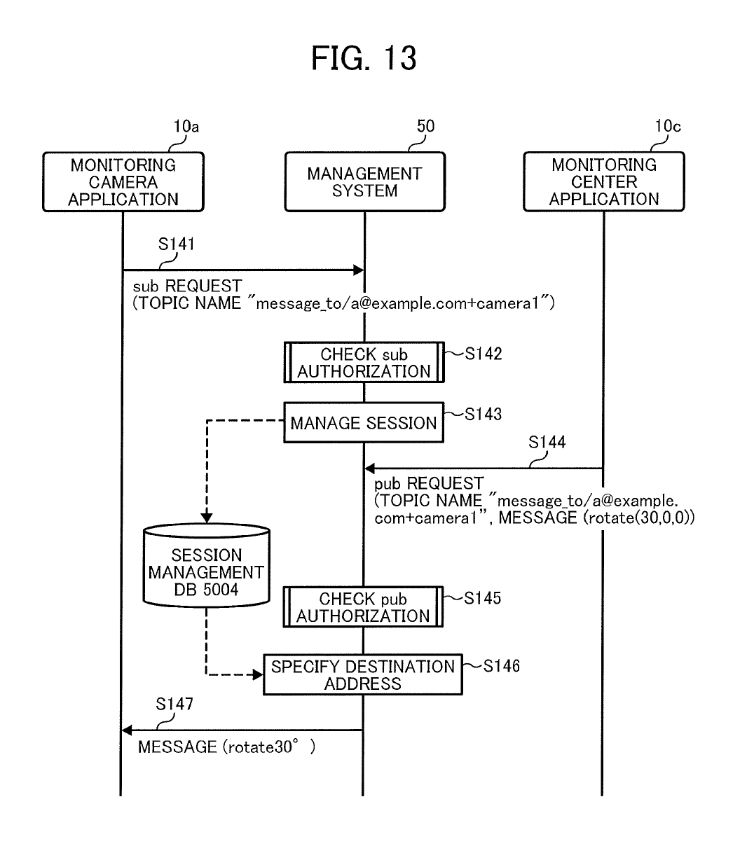

FIG. 13 is a sequence diagram illustrating the processes of sending a message from the communication terminal 10c to the communication terminal 10a, according to the present embodiment.

The sub-request sender 16 of the communication terminal 10a sends a sub request to the management system 50 in order to receive commands from the monitoring center application (step S141). The sub request includes the topic name “message to/a@example.com+camera1” that indicates a message addressed to the account with the account name “a@example.com+camera1”.

The data transmitter and receiver 51 of the management system 50 receives the sub request sent from the communication terminal 10a. The sub acceptance unit 54 of the management system 50 determines whether the account of the sub-request sender has the authority to subscribe to the topic with the topic name “message to/a@example.com+camera1” included in the sub request (step S142).

The processes in the step S142 are similar to those of the step S42 except that the topic name included in the sub request is replaced with “message to/a@example.com+camera1”, the topic ID corresponding to the topic name is replaced with “T02”, the client name of the sub-request sender is replaced with “monitoring camera application”, and the account name of the sub-request sender is replaced with “a@example.com+camera1”. More specifically, the step S142 includes the processes that correspond to the step S42-3 where the sub acceptance unit 54 determines that a group of the topic ID “T02” of the topic name included in the sub request, the account name “a@example.com+camera1” of the sub-request sender, the client name “monitoring camera application” of the sub-request sender, and the authorization information “sub”, indicating the presence of sub authorization, is stored in the user authorization management table. Moreover, the step S142 includes the processes that correspond to the step S42-5 where the sub acceptance unit 54 determines that the sub-request sender has the authority to subscribe to the topic included in the sub request.

When it is determined that the sub-request sender has sub authority, the sub acceptance unit 54 registers the account name “a@example.com+camera1” of sub-request sender, the client name “monitoring camera application”, and the topic ID “T02” of the topic name included in the sub request in association with the session management table (see FIG. 7D) (step S143).

On the other hand, the pub-request sender 15 of the communication terminal 10c sends a pub request to the management system 50 in order to send commands as a message to the monitoring camera application of the communication terminal 10a that the user “a” is using (step S144). The pub request includes the topic name “message to/a@example.com+camera1” that indicates a message addressed to the account with the account name “a@example.com+camera1”, and commands (30,0,0) as a message to rotate the directions of the camera horizontally by 30 degrees in a clockwise direction. Note that the message is not limited to the embodiment described as above, but may be, for example, commands for controlling the zooming or focusing or starting or terminating the capturing.

The data transmitter and receiver 51 of the management system 50 receives the pub request sent from the communication terminal 10c. The pub acceptance unit 53 of the management system 50 determines whether the account of the pub-request sender has the authority to publish the topic with the topic name “message to/a@example.com+camera1” included in the pub request (step S145).

The processes in the step S145 are similar to those of the step S45 except that the topic name included in the pub request is replaced with “message to/a@example.com+camera1”, the topic ID corresponding to the topic name is replaced with “T02”, the client name of the pub-request sender is replaced with “monitoring center application”, and the account name of the pub-request sender is replaced with “a@example.com+operator”. More specifically, the step S145 includes the processes that correspond to the step S45-3 where the pub acceptance unit 53 determines that a group of the topic ID “T02” of the topic name included in the pub request, the account name “a@example.com+operator” of the pub-request sender, the client name “monitoring center application” of the pub-request sender, and the authorization information “pub”, indicating the presence of pub authorization, is stored in the user authorization management table. Further, in the processes that correspond to the step S45-5, the pub acceptance unit 53 determines that the pub-request sender has the authority to publish the topic included in the pub request.

When it is determined that the pub-request sender has pub authority, the pub acceptance unit 53 uses the topic ID “T02” of the topic with the topic name “message to/a@example.com+camera1” included in the pub request as a search key to search the session management table, and obtains a pair of the corresponding account name and client name, i.e., “a@example.com+camera1” and “monitoring camera application”. Accordingly, the pub acceptance unit 53 identifies, as a destination of a message, the monitoring camera application of the communication terminal 10a that logged in the management system 50 with the account name “a@example.com+camera1” (step S146).

The data transmitter and receiver 51 sends the message included in the pub request, i.e., the commands “rotate30°” and the account name “a@example.com+operator” of the pub-request sender, to the monitoring camera application of the communication terminal 10a identified as above. Accordingly, the data transmitter and receiver 11 of the communication terminal 10a receives from the management system 50 the commands as a message and the account name of the pub-request sender, and the communication terminal 10a rotates the camera 112 by 30° in accordance with the received commands.

<<Modification B of Example Embodiment>>

Next, a modification B of the embodiments of the present invention is described. In particular, differences in configuration from the embodiments as described above are described.

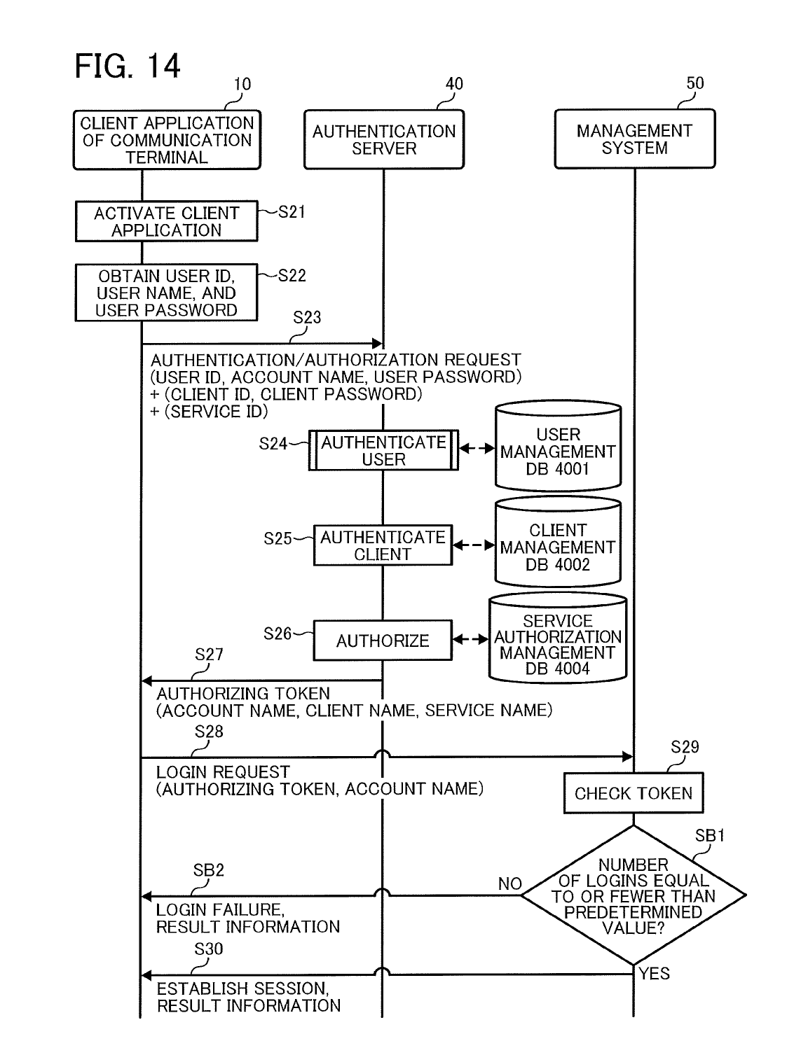

FIG. 14 is a sequence diagram illustrating the authentication processes according to the present embodiment.

The data processor 59 of the management system 50 stores in the memory 5000 the account name of the account that is currently logged in the management system 50.

When the management system 50 succeeds in the authentication of the step S29, the token checker 52 uses the user name of the login request sender as a search key to search the memory 5000, and counts the number of account names that include the same user name as the user name of the login request sender (step SB1). For example, when the user name of the login request sender is “a@example.com”, the token checker 52 counts the number of account names that includes “a@example.com” from the search results.

The token checker 52 determines whether the number of account names that include the same user name as the user name of the login request sender is equal to or fewer than a predetermined value (for example, 100) (step SB1). When the number of account names that include the same user name as the user name of the login request sender is greater than the predetermined value (“NO” in the step SB1), the data transmitter and receiver 51 sends result information indicating the failure in login to the login request sender (step SB2). By so doing, the token checker 52 of the management system 50 limits the login attempt by the login request sender when the number of logins by the same user is greater than a predetermined value.

When the number of account names that include the same user name as the user name of the login request sender is equal to or fewer than the predetermined value (“YES” in the step SB1), the token checker 52 does not restrict the login request from the login request sender. Accordingly, a session between the communication terminal 10 that is the request sender of the login request and the management system 50 is established.

Next, some effects of the above example embodiments of the present invention are described. With the authentication method according to the embodiments described above, The data transmitter and receiver 41 (i.e., an example of a receiver) of the authentication server (i.e., an example of an authentication system) receives an account name (i.e., an example of additional information) where the terminal name (i.e., an example of identification information of a communication terminal) is added to the user name (i.e., an example of identification information of a target to be authenticated). The user authenticator 42 (i.e., an example of an authentication processing unit) of the authentication server 40 authenticates the user with the user name in response to the reception of the account name by the data transmitter and receiver 41. Once the user is authenticated by the user authenticator 42, the authentication server 40 controls the management system 50 (i.e., an example of an authorization system) to authorize subscription (i.e., an example of reception) to a message (i.e., an example of information) that is sent to the account of the above account name among the multiple communication terminals 10. According to the embodiments described above, communication among different communication terminals 10 by the same user can be authenticated with a single user name, and the load on the communication system 1 can be reduced when authentication information is to be generated.

Once the user is authenticated by the user authenticator 42, the token issuing unit 45 (i.e., an example of an output unit) of the authentication server 40 issues (i.e., an example of outputting) an authorizing token (i.e., an example of j) that includes an account name where a terminal name is added to a user name. Due to this configuration, the management system 50 can authorize a user on an account-by-account basis based on the account name included in the authorizing token.

The data transmitter and receiver 41 of the authentication server 40 receives an account name that includes a user name, a terminal name, and a separator (i.e., an example of extraction data) used for extracting the user name. Due to this configuration, the authentication server can extracts a user name from an account name.

When the number of logins (i.e., an example of the number of connections) by different accounts with the same user name reaches a predetermined value, the token checker 52 (i.e., an example of a limiter) of the management system 50 rejects further login requests (i.e., an example of a connection request) to the management system 50 by such accounts with the same user name. Accordingly, login attempts are limited, and the degree of flexibility in service settings improves.

The communication terminal 10 sends an account name where the terminal name of the local communication terminal is added to the input user name to the authentication server 40. Due to the configuration as described above, the communication terminal 10 can create an account name for each user just by managing the terminal name of the local communication terminal.

Further, the control programs for the communication terminal 10, the authentication server 40, and the management system 50 may be recorded in a file in a format installable or executable on a computer-readable recording medium such as the recording medium 106 for distribution. Examples of such recording medium include, but not limited to, compact disc-recordable (CD-R), digital versatile disc (DVD), and Blu-ray disc.

A recording medium such as a CD-ROM storing the programs in the above embodiment and the HD 504 storing those programs may be distributed domestically or internationally as a program product.

The communication terminal 10, the authentication server 40, and the management system 50 according to the embodiment as described above may be configured by a single computer or a plurality of computers to which functions or units are allocated as desired in a divided manner. Alternatively, the authentication server 40 and the management system 50 may be implemented by a single computer (one or more processors).

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. The processing circuit herein includes, for example, devices such as a processor that is programmed to execute software to implement functions, like a processor with electronic circuits, an application specific integrated circuit (ASIC) that is designed to execute the above functions, and a circuit module known in the art.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An authentication system comprising:
a receiver to receive additional information where first identification information of a communication terminal is added to second identification information of a target to be authenticated; and
circuitry to authenticate the target to be authenticated using the second identification information of the target to be authenticated,
wherein when the target to be authenticated is authenticated by the circuitry, an account associated with the additional information is authorized to receive information that is sent from the communication terminal to another communication terminal.

2. The authentication system according to claim 1, wherein
when the target to be authenticated is authenticated by the circuitry, the circuitry outputs authorization data indicating the second identification information of the target to be authenticated and the account associated with the first identification information of the communication terminal.

3. The authentication system according to claim 1, wherein
the receiver further receives extraction data to be used for extracting the second identification information of the target to be authenticated as a part of the additional information.

4. The authentication system according to claim 2, wherein
the receiver further receives extraction data to be used for extracting the second identification information of the target to be authenticated as a part of the additional information.

5. A communication system comprising:
the authentication system according to claim 1; and
the communication terminal.

6. The communication system according to claim 5, wherein
the communication terminal sends to the authentication system the additional information where the first identification information of the communication terminal is added to the second identification information of the target to be authenticated.

7. A communication system comprising:
an authentication system comprising
a receiver to receive additional information where first identification information of a communication terminal is added to second identification information of a target to be authenticated, and
first circuitry to authenticate the target to be authenticated using the second identification information of the target to be authenticated, and to output authorization data indicating the second identification information of the target to be authenticated and an account associated with the first identification information of the communication terminal when the target to be authenticated is authenticated by the first circuitry; and
an authorization system comprising:
second circuitry to authorize the account associated with the authorization data to receive information that is sent from the communication terminal to another communication terminal when the target to be authenticated is authenticated by the first circuitry.

8. The communication system according to claim 7, wherein
the second circuitry limits a connection to the authorization system requested by an account with the second identification information of the target to be authenticated when a number of connections to the authorization system by different accounts with the second identification information of the target to be authenticated reaches a prescribed value.

9. A authentication method comprising:
receiving additional information where first identification information of a communication terminal is added to second identification information of a target to be authenticated; and
authenticating the target to be authenticated using the second identification information of the target to be authenticated,
wherein when the target to be authenticated is authenticated by the authenticating, an account associated with the additional information is authorized to receive information that is sent from the communication terminal to another communication terminal.
